(19) United States
(12) Patent Application Publication
(10) Pub. No.: US 2025/0173805 A1
(43) Pub. Date: May 29, 2025

(54) SYSTEM AND METHOD FOR GENERATING INDIVIDUALIZED STUDENT REPORTS

(71) Applicant: Nikolas Yanek-Chrones, San Diego, CA (US)

(72) Inventor: Nikolas Yanek-Chrones, San Diego, CA (US)

(21) Appl. No.: 18/963,242

(22) Filed: Nov. 27, 2024

Related U.S. Application Data
(60) Provisional application No. 63/603,164, filed on Nov. 28, 2023.

(51) Int. Cl. G06Q 50/20; G06F 21/31

(52) U.S. Cl. CPC G06Q 50/205; G06F 21/31

(57) ABSTRACT

A system and method for generating individualized student reports are disclosed herein. The system includes a subscription verification module for authenticating user access, a data input module for receiving standardized test results and teacher observation files, a data processing module for transforming the data into a format suitable for AI processing, a privacy compliance module for ensuring FERPA compliance, a report generation module for generating reports using AI, and a user interface module for displaying the generated report. The method involves authenticating a user's subscription status, receiving, and processing data, ensuring privacy compliance, using AI to generate reports, and displaying the generated report. The present subject matter streamlines the report generation process, saving educators' time and enhancing the efficiency of special education programs.

### PRIORITY NOTICE

The present application claims priority to U.S. Provisional Patent Application with Ser. No. 63/603,164, filed on Nov. 28, 2023, the disclosure of each incorporated herein by reference in their entirety.

### TECHNICAL FIELD

The present subject matter relates to the field of education technology and, more specifically, the present subject matter pertains to a system and method for generating individualized student reports for special educators.

### BACKGROUND

In the modern educational landscape, the use of standardized tests and assessments has become increasingly prevalent. These tests are designed to provide a comprehensive understanding of a student's academic proficiency and identify areas that may require additional support or intervention. However, the process of generating individualized student reports based on these assessments presents a significant challenge for educators, particularly those working in special education.

The task of translating raw test data into meaningful, individualized reports is often time-consuming and labor-intensive. Educators are required to sift through vast amounts of data, interpret the results, and then compile this information into a format that is both informative and easily understandable. This process can divert valuable time and resources away from direct student instruction and support.

Furthermore, the need for compliance with privacy regulations, such as the Family Educational Rights and Privacy Act (FERPA), adds an additional layer of complexity to the report generation process. Ensuring that student data is handled in a manner that respects privacy rights while still providing a comprehensive overview of a student's academic performance is a delicate balancing act.

Existing solutions, such as data management and report generation systems, have attempted to address these challenges. However, these solutions often rely on predefined templates or algorithms, which may limit the flexibility and customization of the reports. Additionally, these solutions may require district-wide adoption and may not directly integrate with standardized test data.

Therefore, there is a pressing need for a solution that can streamline the report generation process, allowing educators to create individualized student reports efficiently and effectively, while ensuring compliance with privacy regulations. Such a solution would free up educators' time, allowing them to focus more on supporting and instructing their students.

### BRIEF DESCRIPTION OF DRAWINGS

The following detailed description of the present subject matter is better understood when read in conjunction with the appended drawings. For the purpose of illustrating the present subject matter, exemplary constructions of the present subject matter are shown in the drawings. However, the present subject matter is not limited to the specific methods and structures disclosed herein.

FIG. 1 illustrates a block diagram of a system for generating individualized student reports, in accordance with an embodiment of the present subject matter.

FIG. 2 illustrates a block diagram of a method for generating individualized student reports, in accordance with an embodiment of the present subject matter.

FIG. 3 exemplarily illustrates a method for generating individualized student reports, according to an embodiment of the present invention.

FIG. 4 exemplarily illustrates a screenshot of a start screen to generate individualized student reports, according to an embodiment of the present invention.

FIG. 5 exemplarily illustrates a screenshot of selection of WCJ score, according to an embodiment of the present invention.

FIG. 6 exemplarily illustrates a screenshot of selection of teacher response file, according to an embodiment of the present invention.

FIG. 7 exemplarily illustrates a screenshot of selection of CAASSP file, according to an embodiment of the present invention.

FIG. 8 exemplarily illustrates a screenshot of DEMI score input screen, according to an embodiment of the present invention.

FIG. 9 exemplarily illustrates a screenshot of direct user input screen, according to an embodiment of the present invention.

FIG. 10 exemplarily illustrates a screenshot of fast score input screen, according to an embodiment of the present invention.

FIG. 11 exemplarily illustrates a screenshot of Personally Identifying Information (PII) screen, according to an embodiment of the present invention.

FIG. 12 exemplarily illustrates a screenshot of PII edit word screen, according to an embodiment of the present invention.

FIG. 13 exemplarily illustrates a screenshot of loading screen before generation of report, according to an embodiment of the present invention.

FIG. 14 exemplarily illustrates a screenshot of screen having the generated report, according to an embodiment of the present invention.

FIG. 15 exemplarily illustrates a screenshot of user interface that facilitates saving of the generated report, according to an embodiment of the present invention.

### DETAILED DESCRIPTION

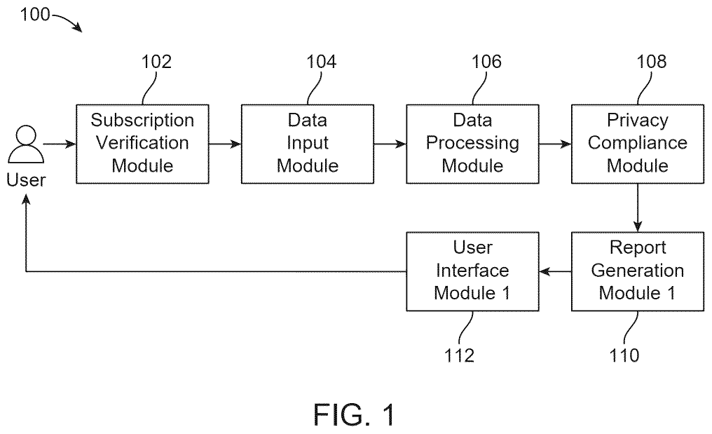

Referring now to the present subject matter in more detail, a system and method for generating individualized student reports is described herein. FIG. 1 illustrates a block diagram of a system for generating individualized student reports, in accordance with an embodiment of the present subject matter. The system, generally indicated by reference numeral 100, is designed to streamline a report generation process, allowing educators to create individualized student reports efficiently and effectively, while ensuring compliance with privacy regulations.

The system 100 includes a subscription verification module 102, which is responsible for authenticating the user's access to the Auto-IEP system. In one embodiment, the subscription verification module 102 interfaces with Stripe, a payment processing platform, to verify that the user maintains an active subscription to Auto-IEP. This verification process is crucial in maintaining the integrity of the system by ensuring that only authorized users can generate reports.

In an alternative embodiment, the subscription verification module 102 could interface with other payment processing platforms or subscription management systems, such as PayPal, Square, or a custom-built system, to verify the user's subscription status.

In yet another embodiment, the subscription verification module 102 could also include additional layers of user authentication, such as two-factor authentication or biometric verification, to further enhance the security of the system. This could involve sending a verification code to the user's registered email or mobile number or using fingerprint or facial recognition technology to confirm the user's identity.

In all embodiments, the primary function of the subscription verification module 102 is to control access to the system and ensure that only authorized users can generate reports, thereby maintaining the security and integrity of the Auto-IEP system.

The system 100 includes a data input module 104, which provides a user-friendly interface for educators to input a variety of standardized test results and teacher observation files. In one embodiment, the data input module 104 supports a range of file types, including but not limited to, Woodcock Johnson IV (.docx), FAST aReading (Excel or Single Score), San Diego Unified's DEMI (Excel or Single Score), and Teacher Observations (Excel). The data input module 104 is designed to streamline the data input process, making it easy and efficient for educators to input data into the system.

In an alternative embodiment, the data input module 104 could support additional or different file types, such as PDFs, CSV files, or proprietary file formats from other standardized tests. The data input module 104 could also include features to automatically extract data from these files, reducing the need for manual data entry.

In yet another embodiment, the data input module 104 could include a feature to directly integrate with online testing platforms or student information systems, allowing for the automatic import of test results and other relevant data. This could further streamline the data input process and reduce the potential for data entry errors.

The system 100 includes a data processing module 106, which is responsible for processing the input data and transforming it into a format suitable for report generation. In one embodiment, for the WCJ-IV test, the data processing module 106 converts tables into dataframes and transforms student's exact scores to categorical format using test-defined score ranges. The student's proficiency in every tested category, along with any notes from the examiner, are added automatically to an AI prompt string. The data processing module 106 is designed to automate the data processing task, making it easy and efficient for educators to generate reports.

In an alternative embodiment, the data processing module 106 could support additional or different standardized tests and could be designed to process different types of data or use different methods of data transformation. For example, it could use machine learning algorithms to identify patterns in the data, or it could use natural language processing techniques to extract relevant information from text-based observation files. For instance, when dealing with the FAST-aReading test, the data processing module 106 enables users to submit an excel table with student names as row indices and student data such as test types or grade level as column indices. This unique capability of the data processing module 106 allows for the processing of multiple FAST aReading scores across different years and seasons, thereby providing a deeper insight into student performance over time.

However, due to prompt token limitations, if two or more scores have the same proficiencies, the data processing module 106 intelligently includes only one in the prompt sentences. This ensures efficient use of resources while maintaining the integrity of the data. The data processing module 106 is capable of handling both single and multiscore options and returns an AI prompt string which encapsulates the proficiencies that a student has demonstrated based on when they took the test, as well as their score range.

In the case of the DIMA, the data processing module 106 exhibits its versatility by converting student proficiency in a certain math subject area into a sentence that mirrors the output on an officially generated DIMA score report. This sentence is then seamlessly added to an AI prompt string.

The data processing module 106 also handles teacher response forms. In this process, the data processing module 106 parses the forms by excluding columns with information that may be personally identifying, ensuring the privacy and confidentiality of student data. It then combines all answers to a question in a single string, which is scrubbed of the student's name to further enhance privacy.

The strings for each question, now anonymized and consolidated, are then combined into an AI prompt string. The process of anonymization is facilitated by a privacy compliance module 108, which is elaborately described in the subsequent sections of the present subject matter. This process allows the system to capture the essence of the teacher's observations and feedback while maintaining the anonymity of the student. The AI prompt string is then used by a report generation module 110 to generate a comprehensive and individualized report. The specific embodiments of the report generation module 110 are described in the subsequent sections of the present subject matter.

The system 100 includes the privacy compliance module 108, which is designed to ensure that the system is fully compliant with the Family Educational Rights and Privacy Act (FERPA). In one embodiment, the privacy compliance module 108 achieves this by blurring test data from specific scores to score ranges and de-identifying all text sent to the AI. The privacy compliance module 108 is crucial in maintaining the privacy and confidentiality of student data.

In an alternative embodiment, the privacy compliance module 108 could use different methods or techniques to ensure privacy compliance. For example, it could use encryption to protect data during transmission and storage, or it could use differential privacy techniques to add statistical noise to the data, thereby preventing the identification of individual students.

In yet another embodiment, the privacy compliance module 108 could include a feature to automatically update its privacy compliance methods in response to changes in privacy laws or regulations. This could involve integrating with a legal database or using machine learning algorithms to predict and adapt to changes in privacy requirements.

The system 100 also includes the report generation module 110, which uses AI to generate individualized student reports based on the processed data. More specifically, the report generation module 110 uses the AI prompt string generated by the data processing module 106. The report generation module 110 sends a request (AI prompt string) to third-party's AI (For example, OpenAI's GPT-4) with the combined AI prompt sentences, along with specially designated prompts for outlining the general context of the report, as well as for separating by subject. The report generation module 110 is designed to automate the report generation process, making it easy and efficient for educators to generate comprehensive and accurate reports.

The system 100 includes a user interface module 112, which is designed to provide a user-friendly interface for educators to interact with the system and generate reports. In one embodiment, the user interface module 112 displays the generated report in an editable text box and provides options to save or generate a new report. The user interface module 112 is designed to make the system easy to use and to facilitate the report generation process.

In an alternative embodiment, the user interface module 112 could include additional features or functionalities to enhance the user experience. For example, it could include a drag-and-drop feature for uploading files, a search function to quickly locate specific data or reports, or customizable settings to allow users to personalize the interface according to their preferences.

In yet another embodiment, the user interface module 112 could be designed to work on different platforms or devices, such as tablets or smartphones, or it could be integrated into a web-based platform, allowing educators to access the system from any device with an internet connection.

In operation, the system 100 provides a streamlined and efficient method for generating individualized student reports. The system 100 leverages artificial intelligence and integrates directly with standardized test data, allowing educators to generate accurate and detailed reports quickly and efficiently.

The process begins with the subscription verification module 102 confirming the user's subscription status. Once verified, the data input module 104 allows educators to input various standardized test results and teacher observation files. The data processing module 106 then processes this data, transforming it into a format suitable for AI processing.

The privacy compliance module 108 ensures that all data is compliant with FERPA, blurring specific test data and de-identifying all text sent to the AI. The report generation module 110 then uses AI to generate individualized student reports based on the processed data.

Finally, the user interface module 112 displays the generated report in an editable text box, providing options for the educator to save or generate a new report.

By automating the report generation process, the system 100 frees up educators' time, allowing them to focus more on supporting and instructing their students. This represents a significant advancement in the field of special education, providing a practical solution to the challenges of report generation and data management.

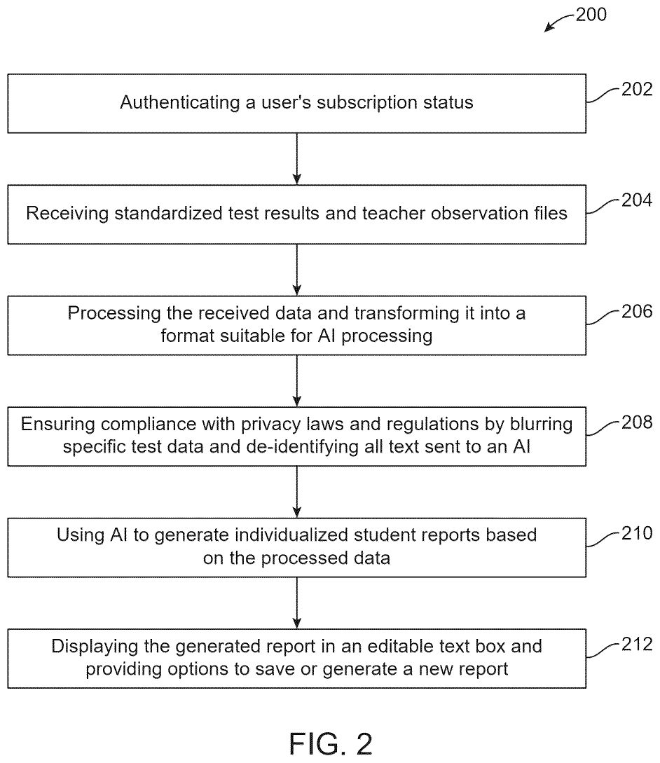

FIG. 2 illustrates a block diagram for a method for generating individualized student reports 200 (hereinafter referred to as method 200), in accordance with an embodiment of the present subject matter. At block 202, the method 200 begins with authenticating a user's subscription status. In an embodiment, this is facilitated through the subscription verification module 102 which interfaces with a payment processing platform such as Stripe to verify the user's subscription status. This ensures that only authorized users can generate reports.

Once the user's subscription status has been authenticated, at block 204, the method 200 proceeds to receive standardized test results and teacher observation files. In an embodiment, this is facilitated by the data input module 104 which supports various file types, including .docx, Excel, and Single Score files. The user can select the input file with a simple button click, making the process user-friendly and efficient.

At block 206, the received data is then processed and transformed into a format suitable for AI processing. In an embodiment, this is facilitated by the data processing module 106 which automatically extracts data from the input files and transforms it into a format that can be understood by the AI. For example, for the WCJ-IV test, the data processing module 106 turns tables into dataframes and transforms student's exact scores to categorical format using test-defined score ranges.

At block 208, the method 200 includes ensuring compliance with privacy laws and regulations by blurring specific test data and de-identifying all text sent to the AI. In one embodiment, this is facilitated through the privacy compliance module 108 which blurs test data from specific scores to score ranges and de-identifies all text sent to the AI, ensuring full compliance with FERPA.

At block 210, the method 200 includes generating individualized student reports based on the processed data by using AI. In an embodiment, this is facilitated by the report generation module 110 which sends a request to third-party's AI (For example, OpenAI's GPT-4) with the combined AI prompt sentences, along with specially designated prompts for outlining the general context of the report, as well as for separating by subject.

Finally, at block 212, the generated report is displayed in an editable text box and the user is provided with options to save or generate a new report. In an embodiment, this is facilitated through the user interface module 112 which provides a user-friendly interface for educators to interact with the system and generate reports. The user interface module 112 can also provide a feature to directly integrate with online testing platforms or student information systems, allowing for the automatic import of test results and other relevant data.

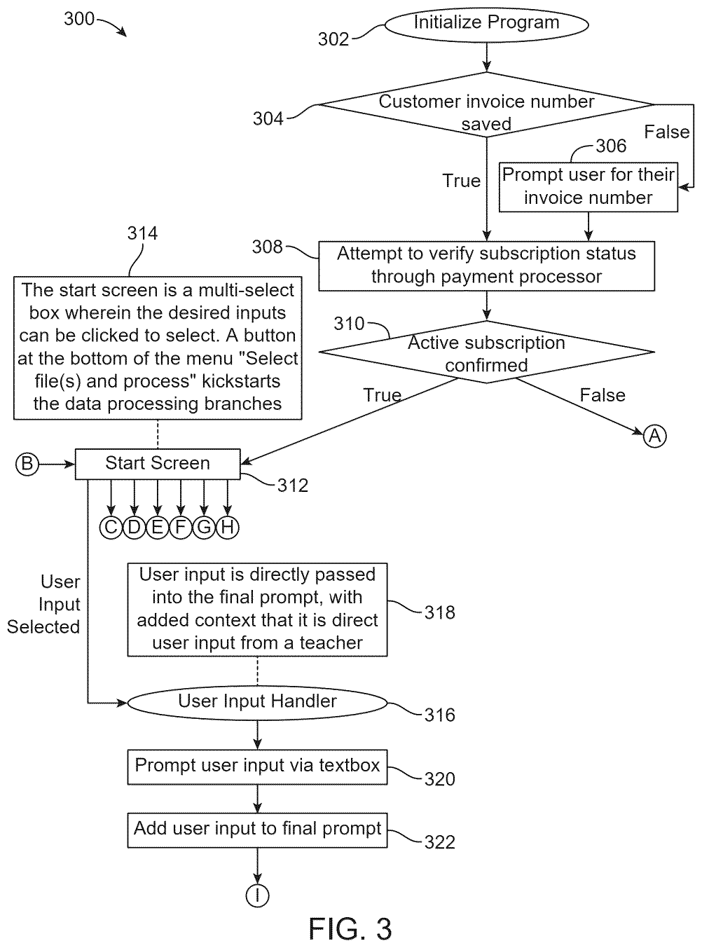

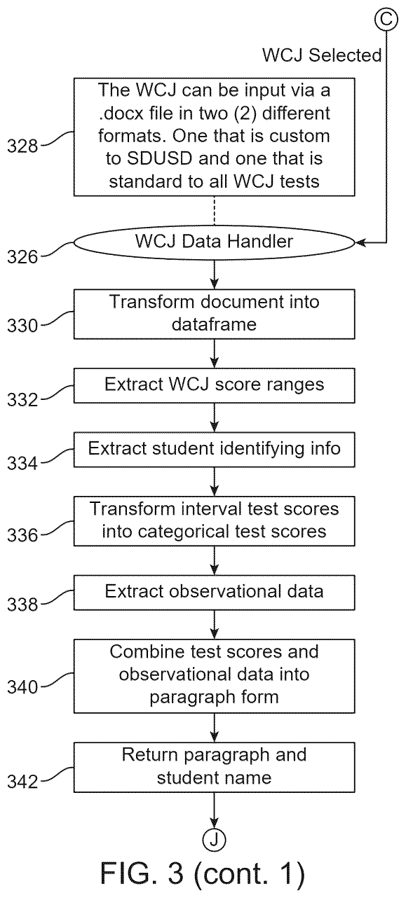

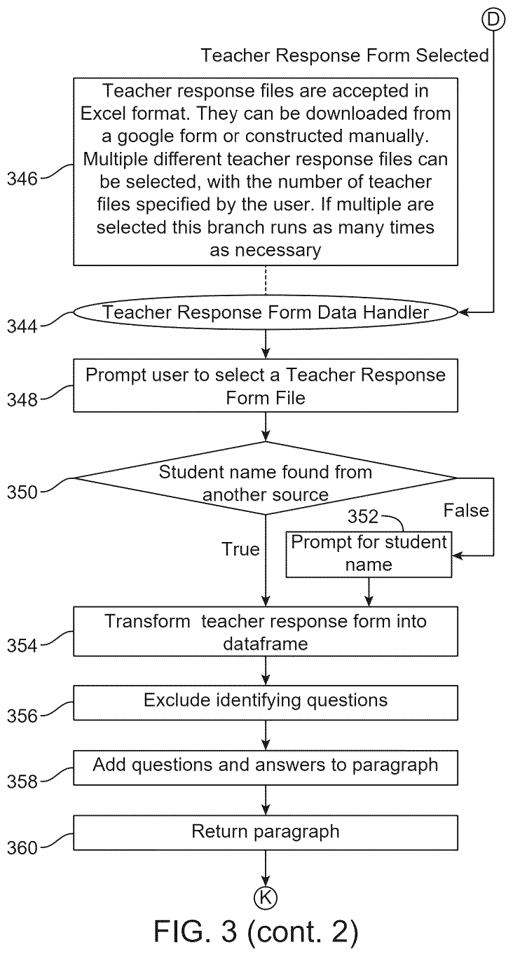

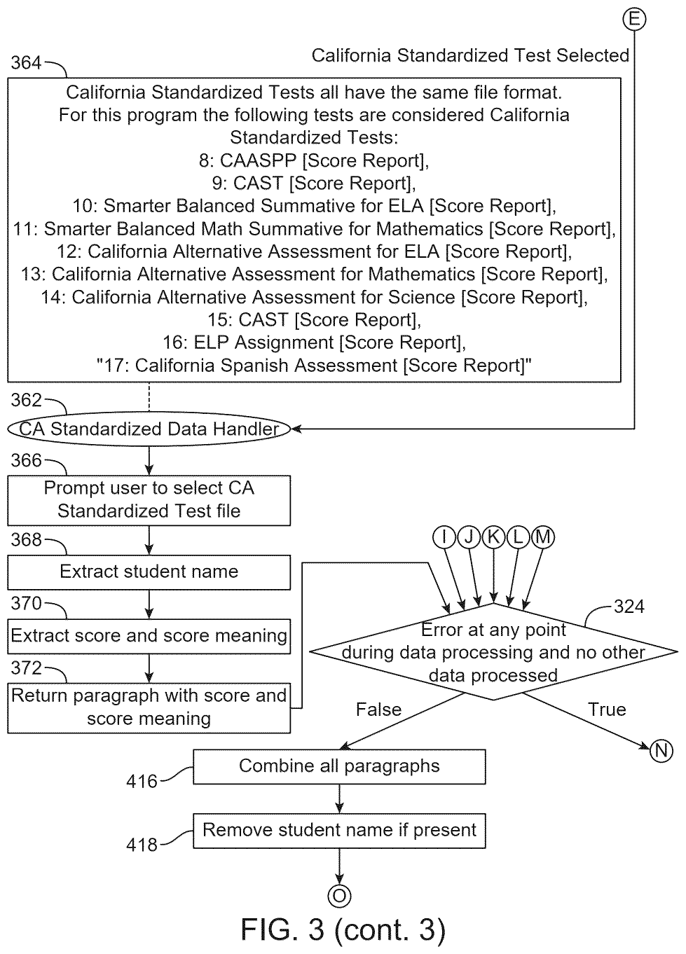

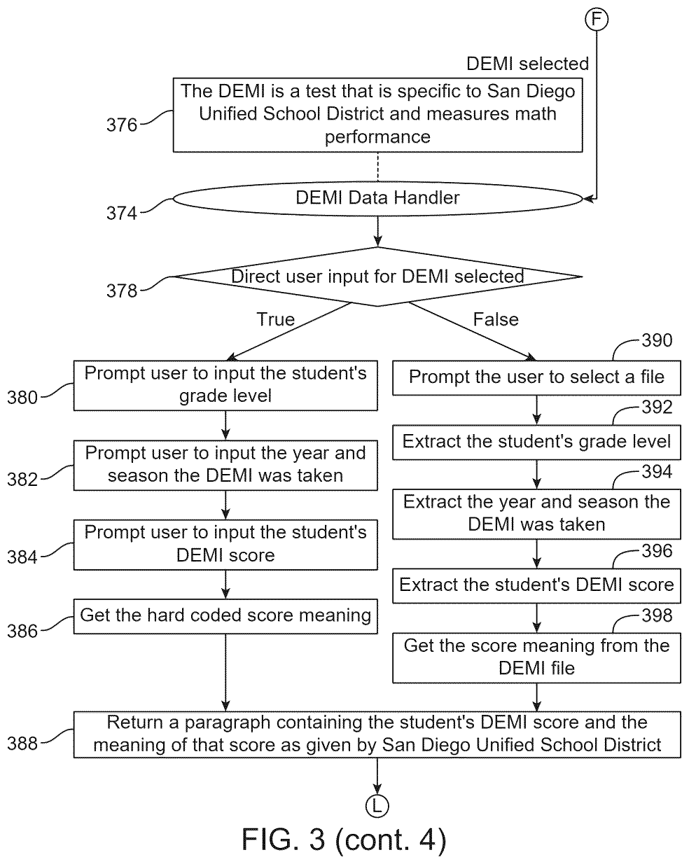

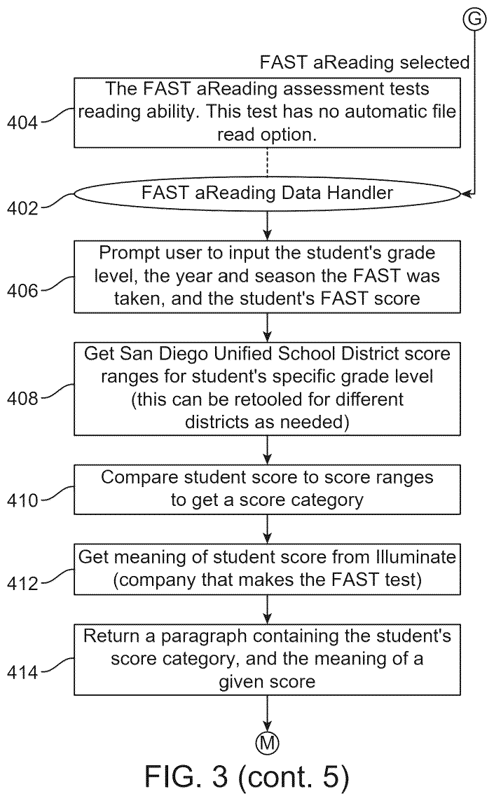

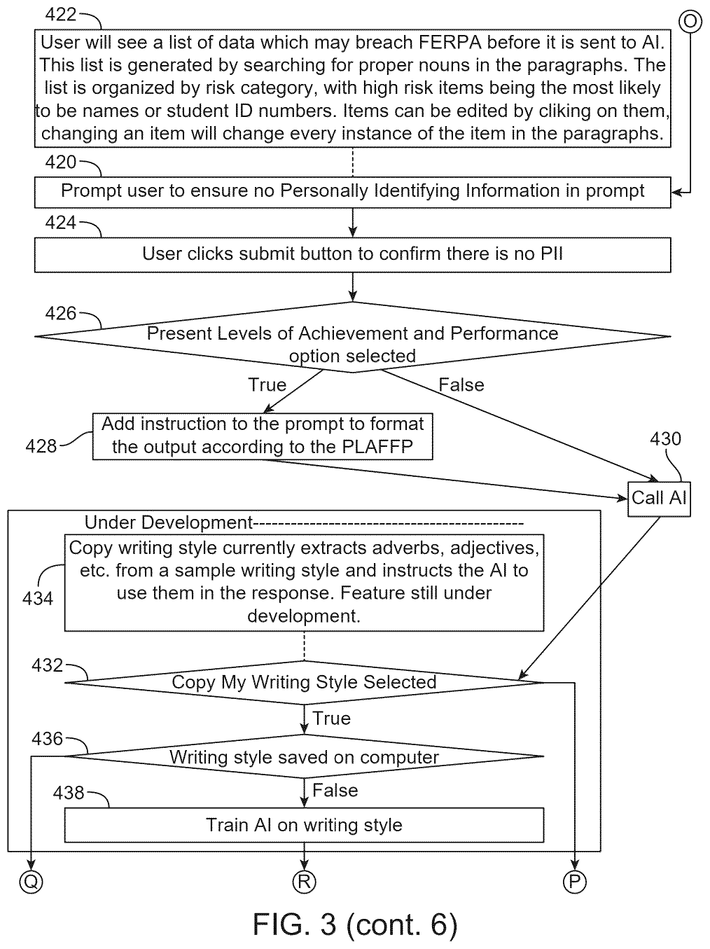

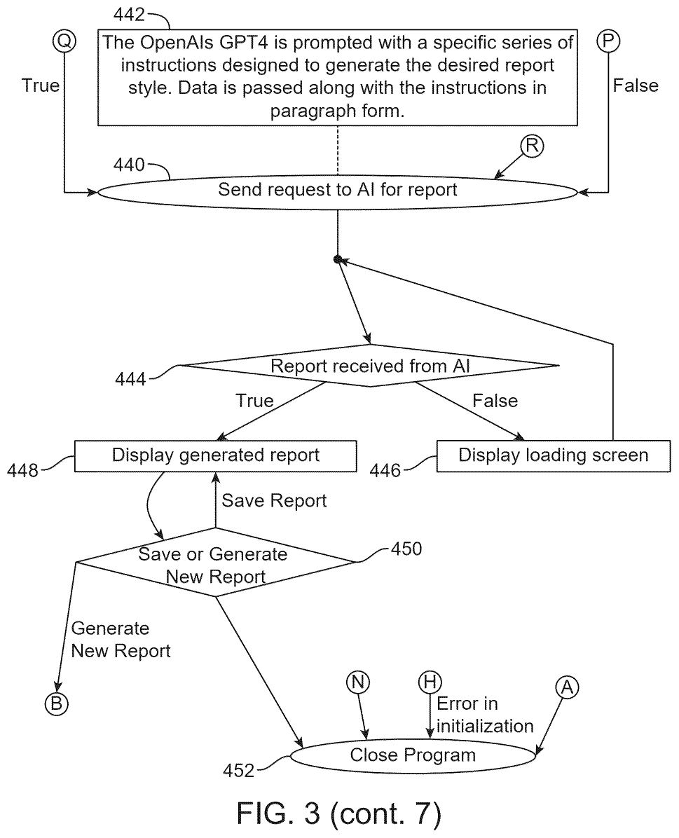

FIG. 3 exemplarily illustrates a method 300 for generating individualized student reports, according to an embodiment of the present invention. At step 302, the program is initialized. At step 304, the system checks if the customer invoice number is saved. If the customer invoice number is not saved, at step 306, the system prompts the user for their invoice number. If the customer invoice number is still not saved, at step 308, the system attempts to verify the subscription status through a payment processor. At step 310, the system checks for confirmation of an active subscription. If an active subscription is not available, the system ends the process.

On confirmation of an active subscription, at step 312, the system displays the start screen. At step 314, the start screen is a multi-select box wherein the desired inputs can be clicked to select. A button at the bottom of the menu, “Select file(s) and process,” kickstarts the data processing branches.

At step 316, the system enables the user to select input. At step 318, the user input is directly passed into the final prompt, with added context that it is direct user input from a teacher. At step 320, the system prompts for user input via a textbox. At step 322, the system adds the user input to the final prompt. At step 324, the system checks for errors at any point during data processing and ensures no other data is processed.”

At step 326, WCJ Data Handler is selected. At step 328, WCJ data handler is explained. The WCJ can be input via a .docx file in two (2) different formats: one that is custom to SDUSD and one that is standard to all WCJ tests. At step 330, the system transforms the document into a dataframe. At step 332, the system extracts WCJ score ranges. At step 334, the system extracts student identifying information. At step 336, the system transforms interval test scores into categorical test scores. At step 338, the system extracts observational data. At step 340, the system combines test scores and observational data into paragraph form. At step 342, the system returns the paragraph and student name. At step 324, the system checks for errors at any point during data processing and ensures no other data is processed.

At step 344, the teacher response form data handler is selected. At step 346, the teacher response file is explained. Teacher response files are accepted in Excel format. They can be downloaded from a Google form or constructed manually. Multiple different teacher response files can be selected, with the number of teacher files specified by the user. If multiple files are selected, this branch runs as many times as necessary. At step 348, the system prompts the user to select a teacher response form file. At step 350, the system checks for a student name found from another source. If it is false, at step 352, the system prompts for the student name. If it is true, at step 354, the system transforms the teacher response form into a dataframe. At step 356, identifying questions are excluded. At step 358, the system adds questions and answers to the paragraph. At step 360, the system returns the paragraph. At step 324, the system checks for errors at any point during data processing and ensures no other data is processed.

At step 362, the California (CA) standardized test is selected. At step 364, the California (CA) standardized test is explained. California Standardized Tests all have the same file format. For this program, the following tests are considered California Standardized Tests: 8: CAASPP [Score Report], 9: CAST [Score Report], 10: Smarter Balanced Summative for ELA [Score Report], 11: Smarter Balanced Math Summative for Mathematics [Score Report], 12: California Alternative Assessment for ELA [Score Report], 13: California Alternative Assessment for Mathematics [Score Report], 14: California Alternative Assessment for Science [Score Report], 15: CAST [Score Report], 16: ELP Assignment [Score Report], “17: California Spanish Assessment [Score Report].” At step 366, the system prompts the user to select a CA Standardized Test file. At step 368, the system extracts the student name. At step 370, the system extracts the score and score meaning. At step 372, the system returns a paragraph with the score and score meaning. At step 324, the system checks for errors at any point during data processing and ensures no other data is processed.

At step 374, DEMI data handler is selected. At step 376, DEMI data handler is explained. The DEMI is a test that is specific to San Diego Unified School District and measures math performance. At step 378, the system checks if direct user input for DEMI is selected. If true, at step 380, the system prompts the user to input the student's grade level. At step 382, the system prompts the user to input the year and season the DEMI was taken. At step 384, the system prompts the user to input the student's DEMI score. At step 386, the system provides the hard-coded score meaning. At step 388, the system returns a paragraph containing the student's DEMI score and the meaning of that score as given by the San Diego Unified School District.

If direct user input for DEMI is not selected, at step 390, the system prompts the user to select a file. At step 392, the system extracts the student's grade level. At step 394, the system extracts the year and season the DEMI was taken. At step 396, the system extracts the student's DEMI score. At step 398, the system gets the score meaning from the DEMI file. The method returns to step 388. At step 324, the system checks for errors at any point during data processing and ensures no other data is processed.

At step 402, the FAST aReading Data Handler is selected. At step 404, FAST aReading assessment is explained. The FAST aReading assessment tests reading ability. This test has no automatic file read option. At step 406, the system prompts the user to input the student's grade level, the year and season the FAST was taken, and the student's FAST score. At step 408, the system retrieves San Diego Unified School District score ranges for the student's specific grade level (this can be retooled for different districts as needed). At step 410, the system compares the student score to score ranges to get a score category. At step 412, the system retrieves the meaning of the student score from Illuminate (the company that makes the FAST test). At step 414, the system returns a paragraph containing the student's score category, and the meaning of the given score. The method returns to step 324. At step 324, the system checks for errors at any point during data processing and ensures no other data is processed.

At step 416, the system combines all paragraphs. At step 418, the system removes the student name if present. At step 420, the system prompts the user to ensure no Personally Identifying Information is in the prompt. At step 422, step 420 is detailedly explained. At step 422, the user will see a list of data which may breach FERPA before it is sent to AI. This list is generated by searching for proper nouns in the paragraphs. The list is organized by risk category, with high-risk items being the most likely to be names or student ID numbers. Items can be edited by clicking on them; changing an item will change every instance of the item in the paragraphs.

At step 424, the user clicks the submit button to confirm there is no Personally Identifying Information (PII). At step 426, the system checks if the Present Levels of Achievement and Performance option is selected. At step 428, the system adds instructions to the prompt to format the output according to the PLAFFP. At step 430, the system calls the AI. At step 432, the system checks if the Copy My Writing Style is selected. At step 434, the Copy My Writing Style is explained. Copy My Writing Style currently extracts adverbs, adjectives, etc., from a sample writing style and instructs the AI to use them in the response. The feature is still under development. At step 436, the system checks if the writing style is saved on the computer. If it is not saved, at step 438, the AI is trained on the writing style. At step 440, the system sends a request to the AI for a report. At step 442, the third-party's AI (For example, OpenAI's GPT-4) is prompted with a specific series of instructions designed to generate the desired report style. Data is passed along with the instructions in paragraph form. At step 444, the system checks if a report is received from the AI. At step 446, if a report is not received, the system displays a loading screen. At step 448, the system displays the generated report. At step 450, the system facilitates saving or generation of the report. At step 452, the method ends.

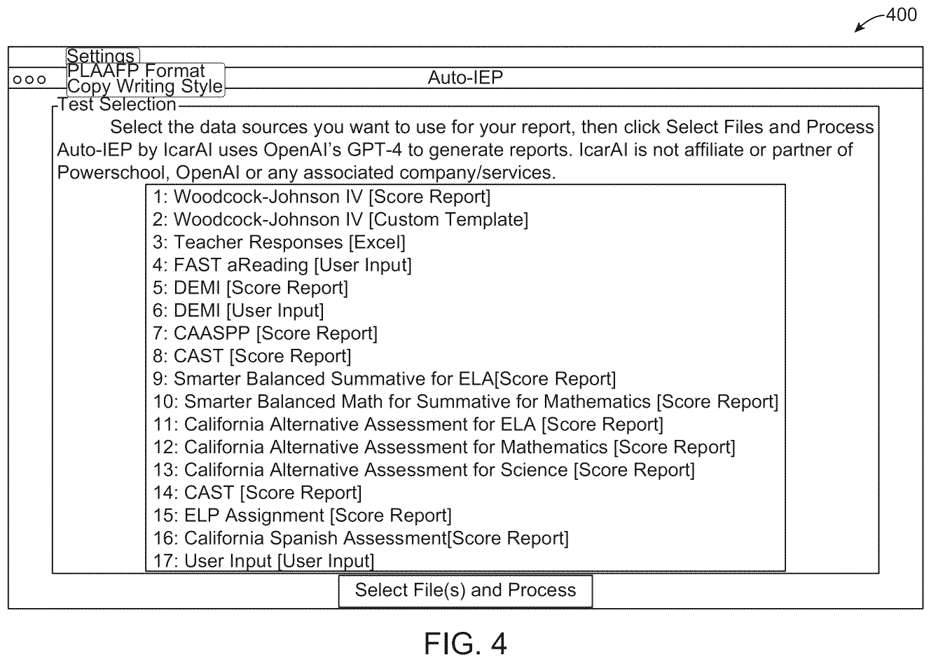

FIG. 4 exemplarily illustrates a screenshot 400 of a start screen or user interface to generate individualized student reports, according to an embodiment of the present invention. The start screen prompts educators or users to select a variety of inputs. The “user input” option allows for exceptionally tailored output. For example, the educator could say, “Write a poem at the end of the report about the student.” The user interface facilitates the selection of the data sources to use for the generation of the report and to select files and processes. A series of windows are presented prompting the educator to select the appropriate file or input the appropriate text.

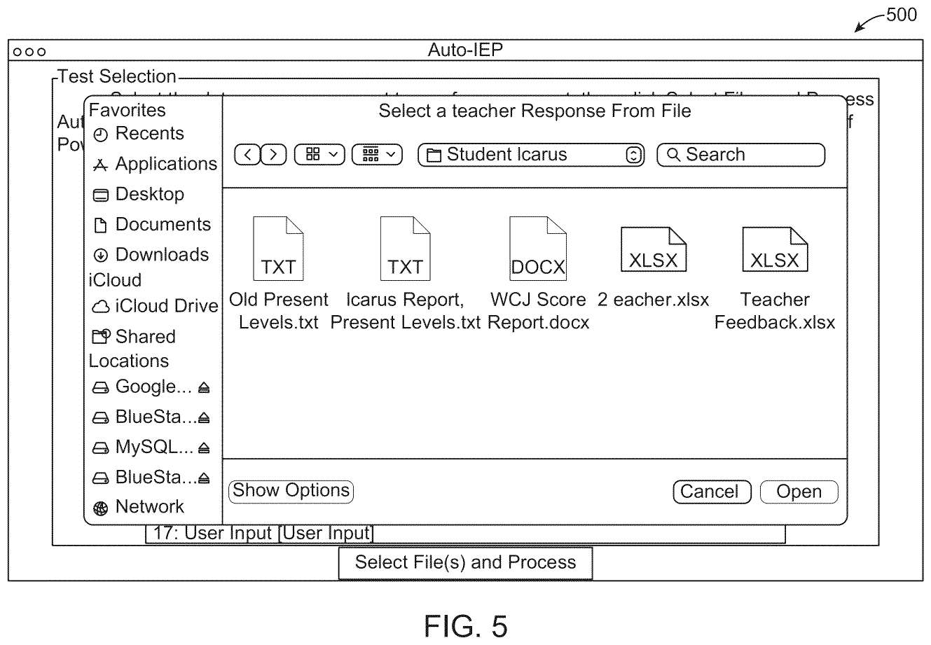

FIG. 5 exemplarily illustrates a screenshot 500 of the selection of a WCJ score, according to an embodiment of the present invention. The user interface facilitates the selection of a WCJ score report.

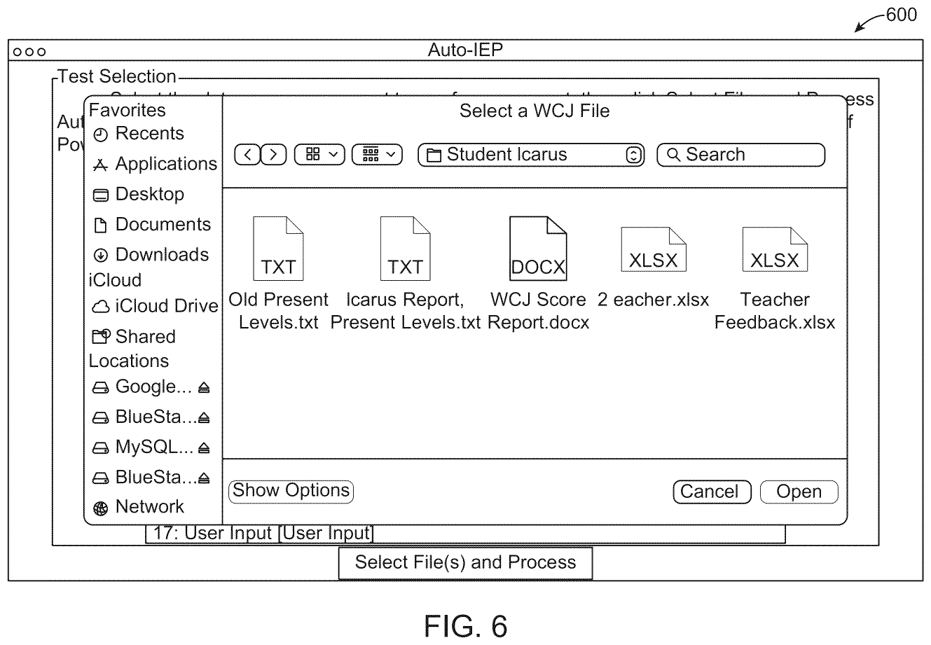

FIG. 6 exemplarily illustrates a screenshot 600 of the selection of a teacher response file, according to an embodiment of the present invention. The user interface facilitates the selection of files related to teacher response.

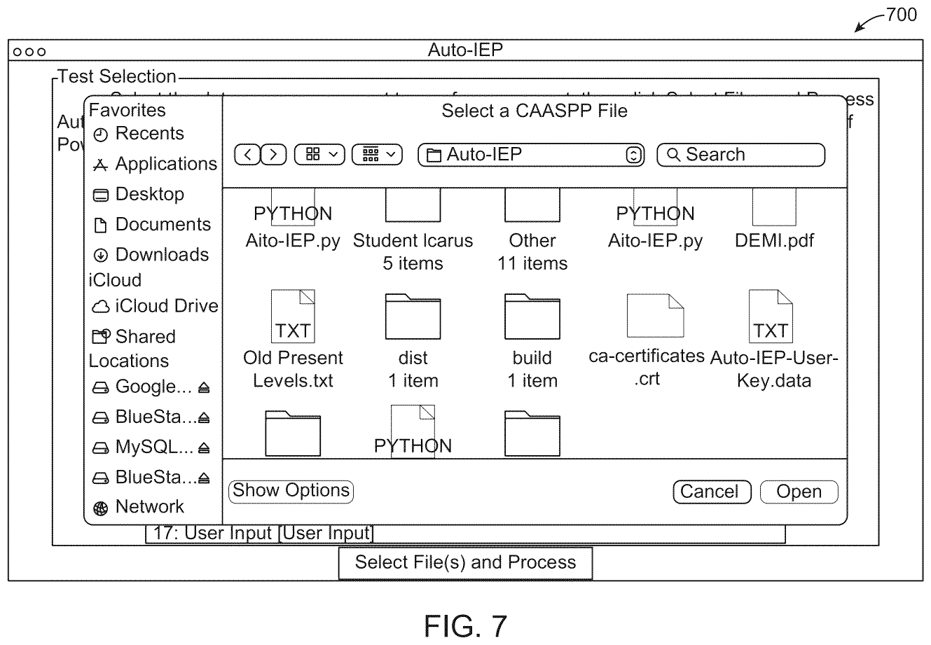

FIG. 7 exemplarily illustrates a screenshot 700 of the selection of a CAASPP file, according to an embodiment of the present invention. The user interface facilitates the selection of a CAASPP file.

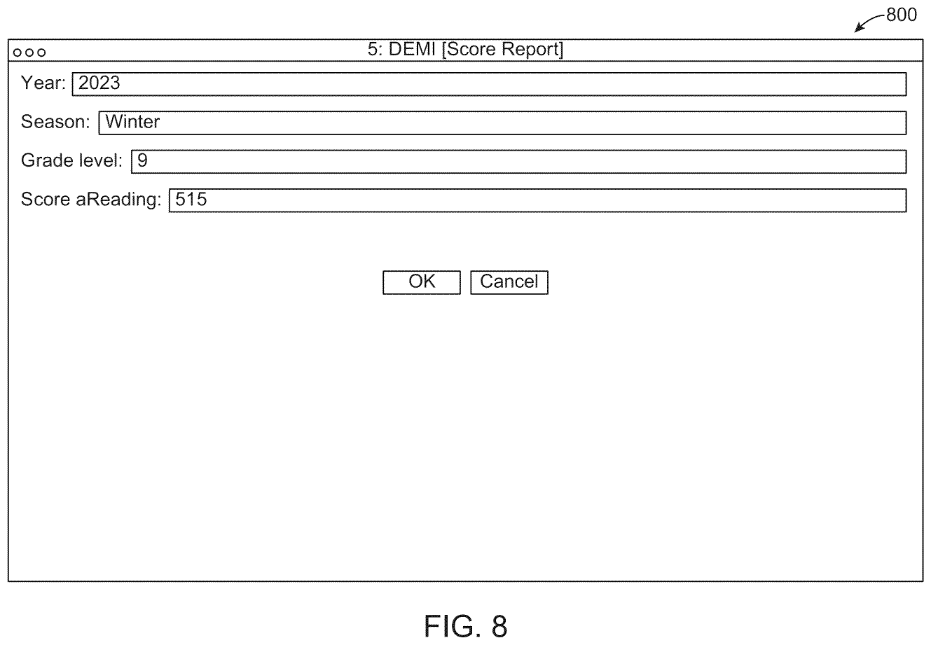

FIG. 8 exemplarily illustrates a screenshot 800 of the DEMI score input screen, according to an embodiment of the present invention. The user interface facilitates the selection of the year, season, grade level, score aReading, and the input of respective data.

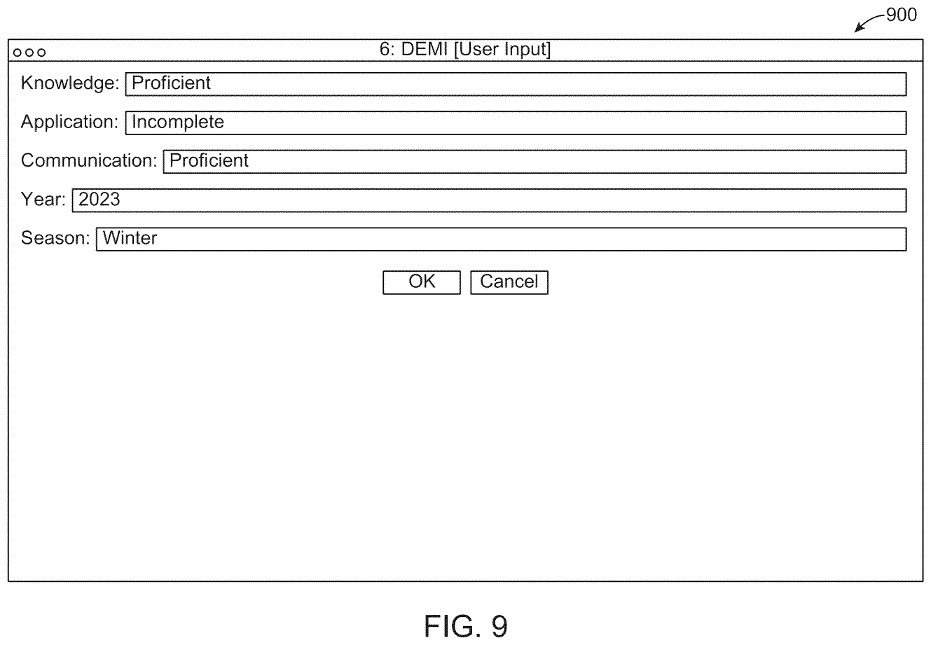

FIG. 9 exemplarily illustrates a screenshot 900 of the direct user input screen, according to an embodiment of the present invention. The user interface facilitates the selection of knowledge, application, communication level, year, and season, and the input of respective data for the generation of the report.

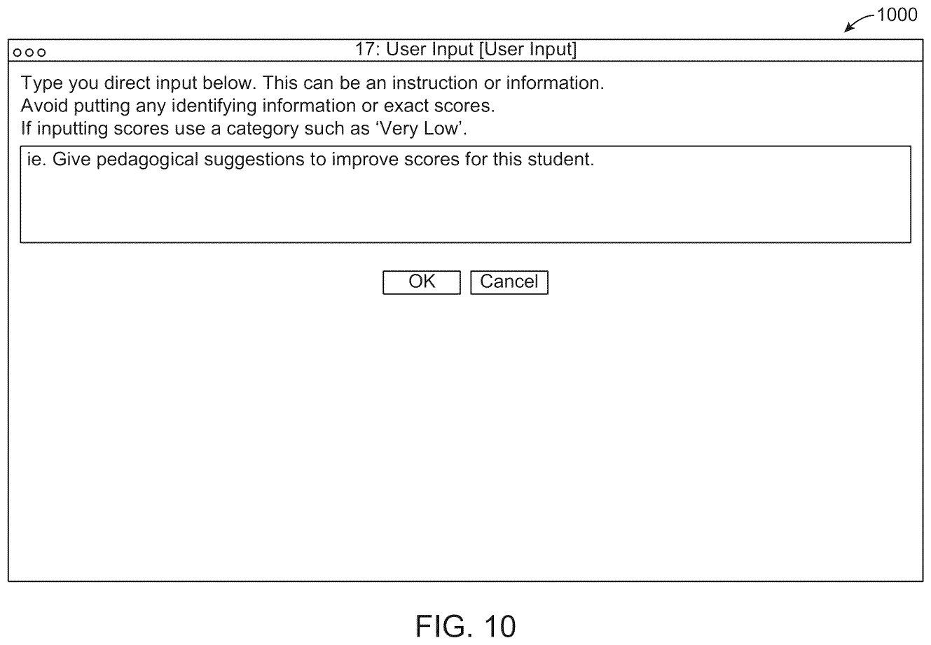

FIG. 10 exemplarily illustrates a screenshot 1000 of the fast score input screen, according to an embodiment of the present invention. The user interface enables the user to type in the input directly. The input could be instructions or information. The user should avoid putting any identification information or exact scores.

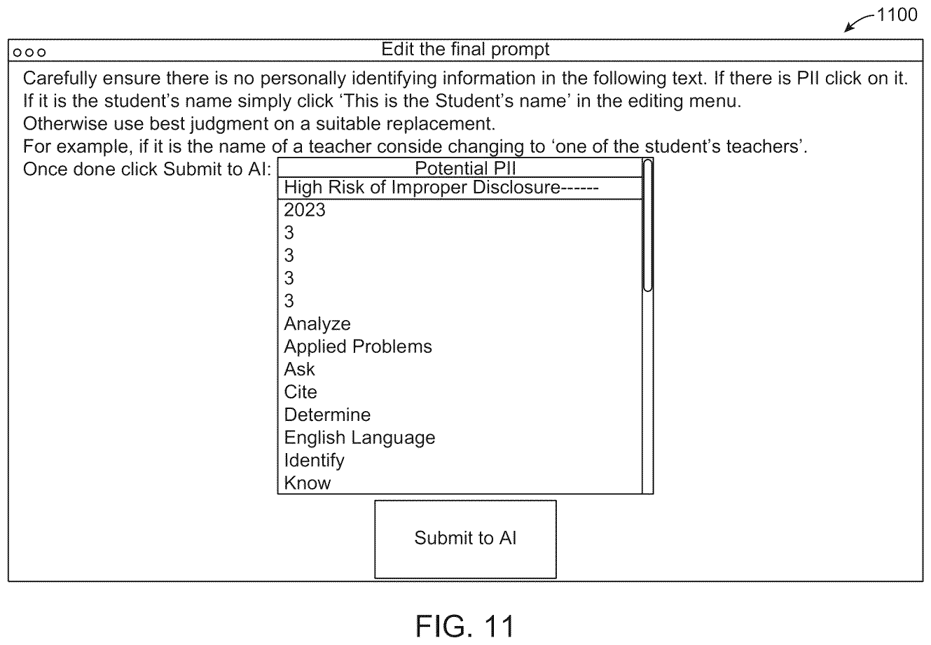

FIG. 11 exemplarily illustrates a screenshot 1100 of the Personally Identifying Information (PII) screen, according to an embodiment of the present invention. The system detects personal information in the input. The system is powered by AI which is run on a local machine and none of the data is shared with outside entities. In another embodiment, the AI may be a third-party AI engine, e.g., OpenAI's GPT4. In yet another embodiment, the system may employ the usage of locally powered AI engine as well as at least one third-party AI engine, and one example of such third-party AI engine is GPT4 of OpenAI. The system enables educators to modify the information before sending it to the AI. The modification could be made by a simple point and click. In the example, there is no PII so we would just click “submit to AI.”

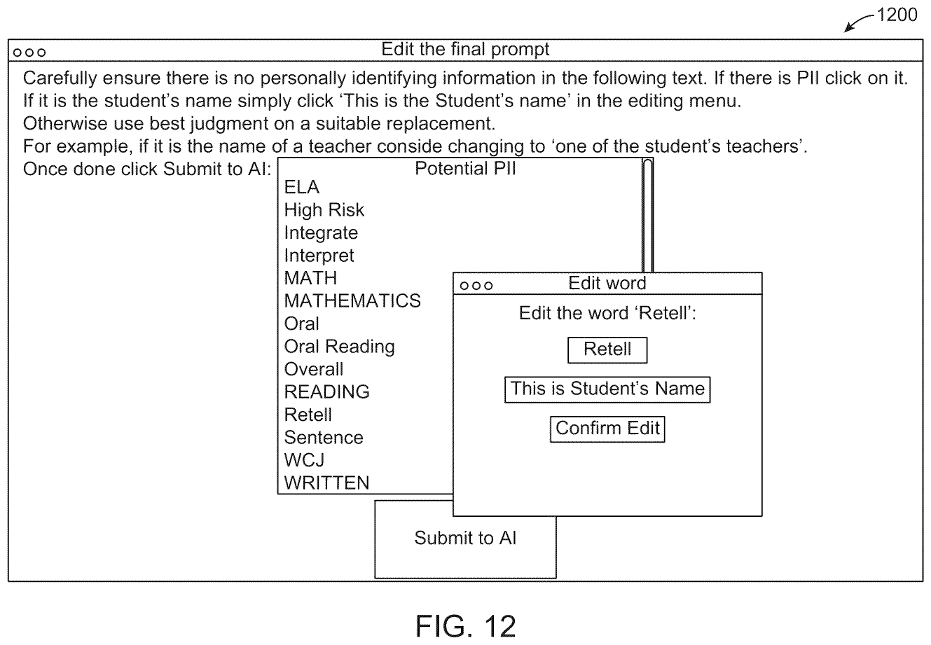

FIG. 12 exemplarily illustrates a screenshot 1200 of the PII edit word screen, according to an embodiment of the present invention. Referring to FIG. 11 and FIG. 12, the user interface ensures that there is no personal identifying information. The user interface includes a list of texts and prompts the user to check if any of the text includes personal information of students. If there is personal information, for example, a name, the user clicks on “This is the student's name” in the editing menu or use their best judgement on a suitable replacement. For example, if it is the name of a teacher consider changing it to “one of the student's teachers.” After editing, the user is enabled to submit the input to the AI.

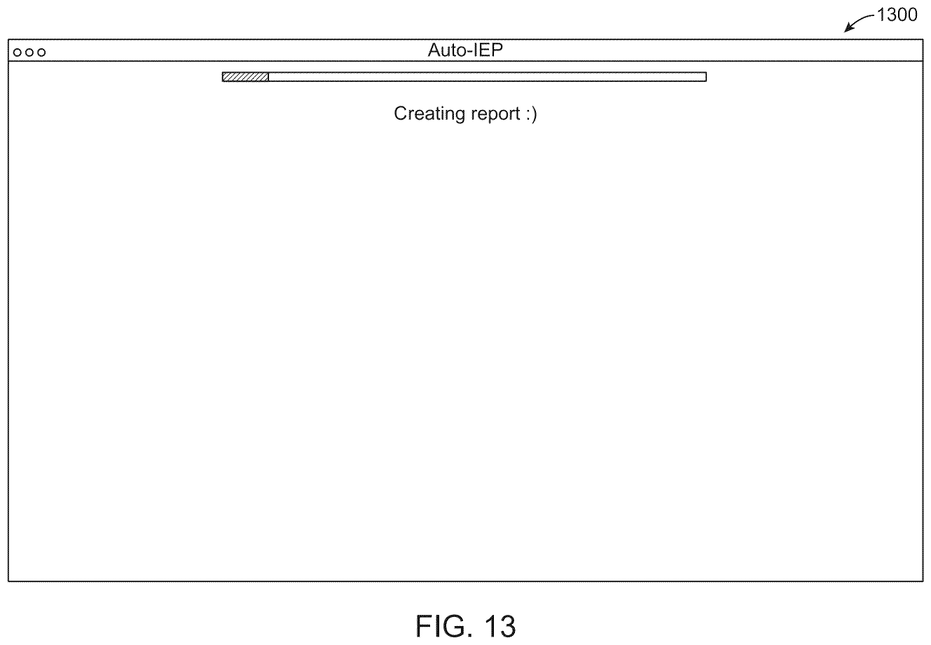

FIG. 13 exemplarily illustrates a screenshot 1300 of the loading screen before generation of the report, according to an embodiment of the present invention. After submission of input, the system displays a loading screen while generating the report.

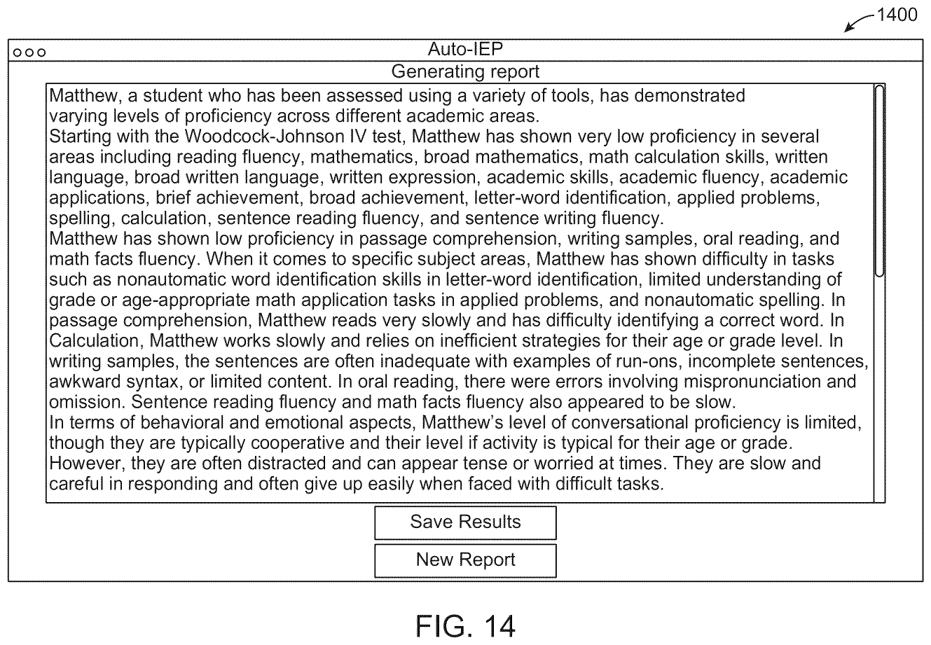

FIG. 14 exemplarily illustrates a screenshot 1400 of the screen having the generated report, according to an embodiment of the present invention. The user interface provides options to save results or generate a new report. The user interface further provides a copy writing style option. This option facilitates generation of a report mimicking the writing style of the educator's submitted text.

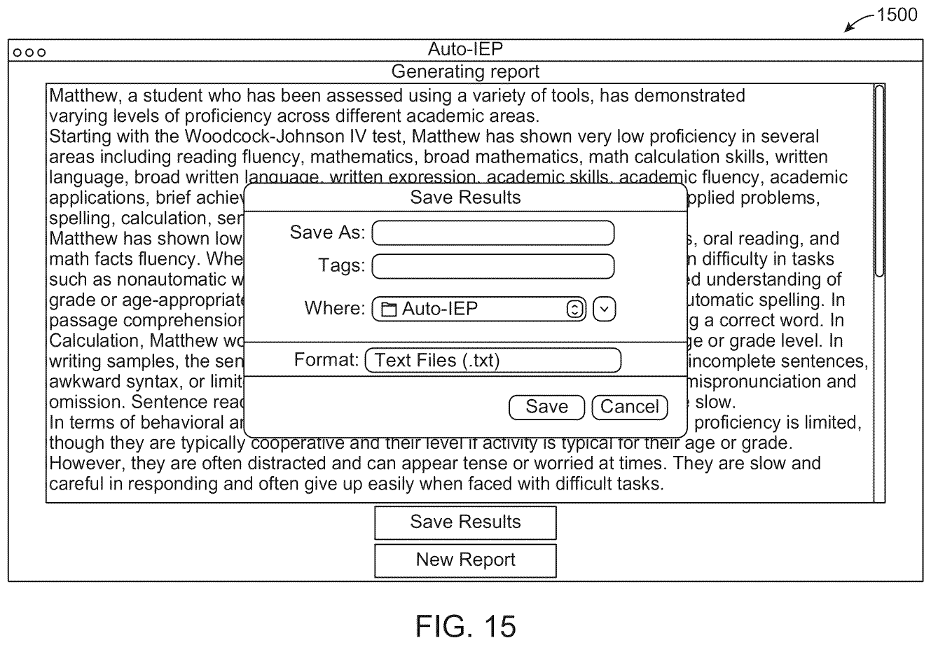

FIG. 15 exemplarily illustrates a screenshot 1500 of the user interface that facilitates saving of the generated report, according to an embodiment of the present invention. The user interface provides options to save results or generate a new report. For saving the report, the user interface provides options such as the save as option, tags option, the where option, and format of the report.

The embodiments described herein are not intended to be exhaustive or to limit the present subject matter to the precise forms disclosed. Rather, the embodiments selected for description have been chosen to enable one skilled in the art to practice the present subject matter. It should be understood that various modifications, adaptations, and alternatives may be employed without departing from the spirit and scope of the present subject matter.

The foregoing description comprises illustrative embodiments of the present subject matter. Having thus described exemplary embodiments of the present subject matter, it should be noted by those skilled in the art that the within disclosures are exemplary only, and that various other alternatives, adaptations, and modifications may be made within the scope of the present subject matter. Merely listing or numbering the steps of a method in a certain order does not constitute any limitation on the order of the steps of that method. Many modifications and other embodiments of the present subject matter will come to mind to one skilled in the art to which this present subject matter pertains having the benefit of the teachings in the foregoing descriptions. Although specific terms may be employed herein, they are used only in generic and descriptive sense and not for purposes of limitation. Accordingly, the present subject matter is not limited to the specific embodiments illustrated herein.

What is claimed is:

1. A system for generating individualized student reports, comprising:
a subscription verification module adapted to control and authenticate user access;
a data input module adapted to receive student data for report generation,
a data processing module adapted to utilize a plurality of data transformation methods to transform the student data and generate an artificial intelligence (AI) prompt string; and
a report generation module adapted to receive the AI prompt string and generate an individualized student report.

2. The system of claim 1, wherein the subscription verification module is adapted to interface with a subscription management system to ensure user authorization.

3. The system of claim 2, wherein the subscription management system includes a payment processing platform.

4. The system of claim 1, wherein the student data includes a plurality of standardized test scores and observation reports.

5. The system of claim 1, wherein the data transformation methods include machine learning algorithms and natural language processing techniques.

6. The system of claim 1, wherein the data input module is further adapted to prompt a user to manually enter categorical information.

7. The system of claim 1, wherein the data input module is further adapted to be integrated with third-party platforms to automatically receive student data generated by the third-party platforms.

8. The system of claim 1, wherein data input module is further adapted to receive different file types.

9. The system of claim 1, wherein the data processing module is further adapted to transform the student data into categorical scores or paragraph form.

10. The system of claim 1, the system further comprising a privacy compliance module adapted to anonymize and redact confidential or private portions of the student data.

11. The system of claim 1, the system further comprising a user interface module adapted to provide a user-friendly interface for teachers and students.

12. A method of generating individualized student reports, comprising:
verifying a user's subscription status with a subscription verification module;
receiving student data via a data input module;
processing and transforming the student data for artificial intelligence (AI) processing via a data processing module;
anonymizing and redacting the student data via a privacy compliance module;
generating an individualized student report with the processed student data; and
providing the individualized student report to a user via a user interface module.

13. The method of claim 12, wherein verifying a user's subscription status includes prompting a user for authentication information and interfacing with a subscription management system.

14. The method of claim 12, wherein receiving student data includes:
prompting a user to select a type of student data, wherein the type of student data includes a plurality of standardized tests or observation reports; and
prompting the user to input categorical information based on the type of student data.

15. The method of claim 12, wherein receiving student data further comprises:
integrating the data input module with third-party platforms including online testing platforms or student information systems;
assigning a type of student data to each third-party platform;
automatically importing files containing student data from the third-party platforms; and
extracting the student data from the third-party platforms.

16. The method of claim 14, wherein the type of standardized tests includes a Woodcock Johnson-IV (WCJ-IV), a California Standardized test, and a District Essential Mathematics Indicator assessment (DEMI).

17. The method of claim 12, wherein processing and transforming the student data further comprises:
utilizing a plurality of data transformation methods to extract test scores or observational data;
converting the test scores to categorical scores;
converting the observational data into paragraph form; and
generating an AI prompt string.

18. The method of claim 12, wherein the observation reports include a teacher response form.

19. The method of claim 17, wherein generating the individualized student report includes querying an AI engine with the AI prompt string.

20. The method of claim 12, wherein the user interface module is adapted to provide a user-friendly interface for students and teachers.
